(19) United States
(12) Patent Application Publication
(10) Pub. No.: US 2016/0092583 A1
(43) Pub. Date: Mar. 31, 2016

(54) SYSTEM AND METHOD FOR TRANSACTING DIGITAL CONTENT SEARCH USING TITLES REFERENCED IN BROWSING ACTIVITY OF A USER

(71) Applicant: Kobo Inc., Toronto (CA)

(72) Inventor: Sneha Patel, Mississauga (CA)

(21) Appl. No.: 14/502,421

(22) Filed: Sep. 30, 2014

(51) Int. Cl. G06F 17/30; H04L 29/08; G06Q 30/06

(52) U.S. Cl. CPC G06F 17/30867; G06Q 30/0633; G06Q 30/0635; H04L 67/306; H04L 67/02; G06F 17/30876

(57) ABSTRACT

A computing device includes browser plugin that is operable to detect when a user selects a content item on a web resource, the web resource (e.g., web page) having been accessed by a browser application. The computing device implements and/or accesses resource to determine a title of a work from the content item. The computing device further performs operations to associate the title with an account maintained at a network service from which a digital form of the work can be obtained, and the account is linked to the computing device.

### TECHNICAL FIELD

Examples described herein relate to a system and method for transacting a digital content search using titles referenced in browsing activity of a user.

### BACKGROUND

An electronic personal display is a mobile electronic device that displays information to a user. While an electronic personal display is generally capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like). These devices include web browsers, and provide platforms on which various kinds of service applications can be executed to receive or otherwise render content from a corresponding network service.

An electronic reader, also known as an e-reader device, is an electronic personal display that is used for reading electronic books (eBooks), electronic magazines, and other digital content. For example, digital content of an e-book is displayed as alphanumeric characters and/or graphic images on a display of an e-reader such that a user may read the digital content much in the same way as reading the analog content of a printed page in a paper-based book. An e-reader device provides a convenient format to store, transport, and view a large collection of digital content that would otherwise potentially take up a large volume of space in traditional paper format.

E-reader devices are purpose-built devices designed to perform especially well at displaying readable content. For example, a purpose built e-reader device includes a display that reduces glare, performs well in highly lit conditions, and/or mimics the look of text on actual paper. While such purpose built e-reader devices excel at displaying content for a user to read, they can also perform other functions, such as displaying images, emitting audio, recording audio, and web surfing, among others.

There also exist numerous kinds of consumer devices that can receive services and resources from a network service. Such devices can operate service applications that link the device to a network service from which content of a particular kind can be received or otherwise obtained. Typically, the service applications include functionality that link individual devices to a corresponding account maintained with a specific service. For example, e-reader devices typically link to an online bookstore, and media playback devices often include applications which enable the user to access an online media store. In this context, the user accounts can enable the user to receive the full benefit and functionality of the device, as well as to perform acquisition activities for acquiring titles to works of interest in electronic form.

### BRIEF DESCRIPTION OF THE DRAWINGS

FIG. 1 illustrates a system for promoting or advancing acquisition activities for titles of works that are of interest to a user and which are referenced or depicted in web content browsed by the user, according to an embodiment.

FIG. 2 illustrates an example of an e-reading device for use with one or more embodiments described herein.

FIG. 3 illustrates an e-reading system which is implemented in connection with a title determination and acquisition process, according to one or more embodiments.

FIG. 4 illustrates a system for identifying a title of a work that is of interest to a user, from analysis of web content selected by the user.

FIG. 5 illustrates an example method for analyzing user selected web content to identify a title of a work that is referenced by the web content, according to an embodiment.

FIG. 6 illustrates an example method for implementing one or more acquisition operations in response to identifying a referenced title in user selected web content, according to an embodiment.

FIG. 7A and FIG. 7B illustrate examples for implementing title determination using a browser plugin for detecting in processing user-selected web content, according to one or more embodiments.

### DETAILED DESCRIPTION

Examples described herein include a system and device having functionality for automating steps to initiate or advance acquisition of titles for works that are referenced or depicted in web content browsed by the user. As described below, examples enable a user to initiate acquisition activity for a title upon encountering a reference or depiction (e.g., in an image) of the title when browsing web content. When the title is referenced or depicted in web content, the title is provided without e-commerce or transaction links which enable purchasing or other acquisition activities. Rather, the title can, for example, appear as a subject or contextual element of an article, or alternatively, as an element depicted in an image (e.g., a celebrity carrying a book, an advertisement for a movie, etc.).

According to at least some embodiments, a user can select a portion of a rendered web page which references or depicts a title of a work that is of interest to the user. A series of operations can be transparently performed, without interrupting a browsing session of the user, in order to initiate or advance actions for acquiring an electronic version of the title from a network service. Among the actions that can be performed, examples described herein automate (i) adding the title of the work to an acquisition queue associated with an account of a user at a network service where the electronic version of the title can be obtained; (ii) generating a transaction interface, transaction order, or providing transaction information, to enable the user to evaluate and/or purchase the electronic version of the title with additional input; or (iii) transferring a right of possession for the title to the user, including debiting funds or other consideration from an account of the user.

According to some embodiments, a computing device includes a browser plugin that is operable to detect when a user selects a content item of a web resource (e.g., web page), having accessed the web resource using a browser application. The computing device can implement and/or accesses remote resources to determine a title of a work from the content item. The computing device further performs operations to associate the title with a linked account maintained at a network service from which a digital form of the work can be obtained.

Among other benefits, examples such as described herein enable a user to initiate or trigger acquisition of a work (e.g., e-book, movie) from a network service when the user encounters content which references a title of interest. For example, embodiments recognize that content provided over the World Wide Web often directly or indirectly references entertainment and topics of interest, and in this context, users often encounter articles or images depicting a work that is of interest to them. Under conventional approaches, a user must take steps to recall an encountered title (e.g., write down a title of a novel of interest) and then recall to purchase or otherwise acquire the title at a later time. In contrast to conventional approaches, examples such as described (i) enable the user to identify a content item of interest when browsing a web page, and (ii) without leaving the web page, invoke a series of programmatic actions that result in a title which is referenced or depicted in the content item to be made available for purchase or acquisition.

Among variations, an identified title can be associated or linked to a user account that is provided with a network service from which a digital version of the referenced work can be obtained. By way of example, a title that is referenced or depicted in web content can be added to the user account (e.g., purchased automatically), or alternatively, added to an acquisition queue or wish-list of the user. Still further, the network service can provide a transaction interface, or alternatively provide transaction information, for enabling the user to view requirements for purchasing the identified title. In one variation, the activities and operations that are performed in making the title available for access or purchase to the user can be performed asynchronously and/or transparently, so as to not disturb the browsing experience of the user. For example, the user can trigger an application or other interface on the network service to view an acquisition queue or wish-list. Alternatively, the user can be provided transaction information about various titles identified from web content which reference or depict the respective titles.

According to another aspect, programmatic operations are implemented to detect when a user selects a portion of web content that is accessed by execution of a browser operating on the user's computing device. The selection of the web content may include content that depicts or references a title of a work. In particular, a title that appears in web content selected by the user can be referenced or depicted in context of other content, without use of an e-commerce link for enabling acquisition of the title. Analysis can be performed on the selected web content to determine at least some of the terms for a likely title that appears in the selected web content. The identified terms for the title are communicated to a network service to confirm or determine the title, as well as to determine transaction information for the title. In some variations, the network service can initiate or execute a transaction to confer to the user a right of possession to the electronic version of the referenced title.

According to another aspect, a system includes (i) one or more servers to provide a network service, (ii) a service application, and (iii) a browser component (e.g., plugin) that execute on a computing device of a user. The browser component operates to identify a user selecting a section of a web resource accessed through a browser operating on a computing device of the user. The section of the web resource can include content that depicts or references a title of a work, without use of an e-commerce link for the work. The browser component initiates or performs content analysis to identify at least a set of terms for a likely title that is referenced or depicted in the work. At least one of the service application or plugin operate to identify terms from the title of the work, and the terms are communicated to the servers of the network service. The servers of the network service perform one or operations that either promote or accomplish a transaction to transfer an electronic version of the title to an account associated with the computing device.

With regard to examples described below, a title to a work can reference, for example, the title of a literary work, movie, musical work, television program, game, or computer program. A title of a literary work can include, for example, works of fiction and nonfiction, compilations, periodicals (e.g., magazines, comic books, newspapers, journals, etc.), and reference books (dictionaries, text books, cooking books, etc.).

Numerous examples are described below in the context of literary works, and more specifically, in context of the e-reading devices that communicate with a network service to obtain e-books. While such examples are described in detail, variations to embodiments described can be implemented for purpose of obtaining other forms of content from network services. In particular, embodiments described herein can be implemented to identify titles to works of forms other than literary works, such as titles for movies, television programs, music, games, computer programs or other kinds of content.

An “e-reading device” can refer to any computing device that can display or otherwise render an e-book. By way of example, an e-reading device can include a mobile computing device on which an e-reading application can be executed to render content that includes e-books (e.g., comic books, magazines etc.). Such mobile computing devices can include, for example, a mufti-functional computing device for cellular telephony/messaging (e.g., feature phone or smart phone), a tablet device, an ultramobile computing device, or a wearable computing device with a form factor of a wearable accessory device (e.g., smart watch or bracelet, glasswear integrated with computing device, etc.). As another example, an e-reading device can include an e-reader device, such as a purpose-built device that is optimized for e-reading experience (e.g., with E-ink displays etc.).

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

### System Description

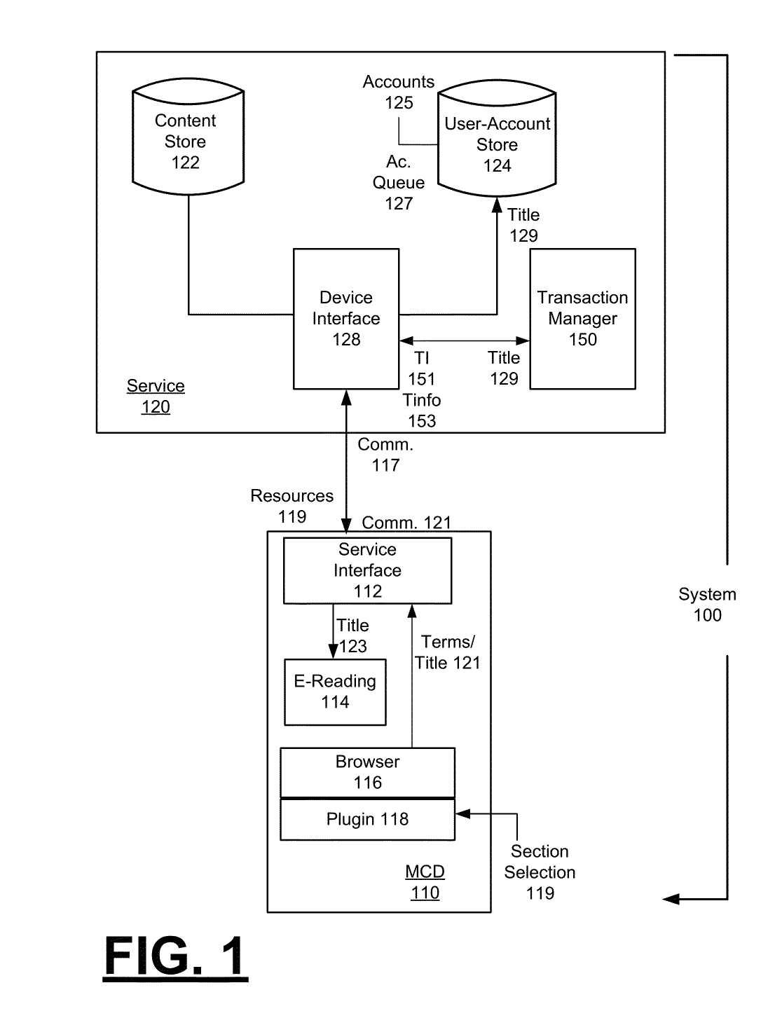

FIG. 1 illustrates a system for promoting or advancing acquisition activities for titles of works that are of interest to a user and which are referenced or depicted in web content browsed by the user, according to an embodiment. In an example of FIG. 1, system 100 includes a computing device 110 and a network service 120. In some examples, the computing device 110 can operate as an e-reading device, and the network service 120 provides e-books and other forms of content to the computing device via, for example, a service application or platform. While examples such as described with FIG. 1 are provided in the context of e-reading devices and services, variations provide for the computing device of FIG. 1 to be operated as another type of content rendering device (e.g., video playback device for movies and television programming, music playback device, gaming device, etc.). Likewise, in variations, the network service 120 can provide alternative types of content for acquisition and content, including movie and television programming, music, gaming, etc.

Accordingly, in an example of FIG. 1, the network service 120 includes one or multiple servers and other computing resources that provide various services in connection with one or more applications that are installed on the computing device 110. By way of example, in one implementation, the network service 120 can provide e-book services which communicate with corresponding e-reading functionality provided on the computing device 110. The e-book services can enable e-books (including electronic magazines and other periodicals) to be downloaded onto the computing device 110, as well as archived from the computing device 110. The network service 120 can also provide other forms of content for download or streaming, such as videos or music. In this way, the network service 120 can provide various other content services, including content rendering services (e.g., streaming media) or other network-application environments or services.

The computing device 110 can correspond to any electronic personal display device on which applications and application resources (e.g., e-books, media files, documents) can be rendered and consumed. For example, the computing device 110 can correspond to a tablet or a telephony/messaging device (e.g., smart phone). In one implementation, for example, computing device 110 can correspond to a mobile computing device (e.g., tablet) that runs an e-reading application to link the device to the network service 120 in order to enable e-books provided through the service to be viewed and consumed. Still further, by way of example, the computing device 110 can be equipped with hardware and software to optimize certain application activities, such as rendering of electronic content (e.g., e-books, including electronic magazines and other periodicals). For example, the computing device 110 can have a tablet like form factor, although variations are possible. In some cases, the computing device 110 can also have an E-ink display.

In additional detail, the network service 120 can include a device interface 128, a resource store 122 and a user account store 124. The user account store 124 can associate the computing device 110 with a user and with an account 125. The account 125 can also be associated with one or more application resources (e.g., content item such as an e-books), which can be stored in the resource store 122. As described further, the user account store 124 can retain metadata for individual accounts 125 to identify resources that have been purchased or made available for consumption for a given account. The computing device 110 may be associated with the user account 125, and multiple devices may be associated with the same account. As described in greater detail below, the computing device 110 can store resources 119 (e.g., e-books) that are purchased or otherwise made available to the user of the computing device 110, as well as to archive e-books and other digital content items that have been purchased for the user account 125, but are not stored on the particular computing device.

The network service 120 can manage the user account 125 by linking titles of works that are owned by the user to the account. The linking of titles to the account 125 can enable the user to receive or download copies of the titles, using computing device 110 and/or other devices that are linked to the network service 120. In some examples, the concept of ownership of titles to works includes a right of the user to possess an electronic copy of the title, and the copy can be stored on network service 120 or on the computing device 110.

In some embodiments, network service 120 links one or more queue accusation lists with the account 125 of the user. The acquisition queue 127 (sometimes referred to as a “wish-list”) can identify titles that the user wishes to purchase, have purchased on behalf of the user, or which the user may want to purchase pending further research and/or interest.

The computing device 110 can include a service interface 112, an e-reading component 114, a browser 116 and a browser plugin 118. The computing device 110 can execute the service interface 112 to receive resources 119 and data from the network service 120. The service interface 112 can signal, to the network service 120, an identifier for the user and/or user account. The service interface 112 can interface with the network service 120 to receive resources 119 such as applications and content items (e.g., e-books, music files, etc.). Optionally, the computing device 110 can communicate with multiple services in order to receive resources 119. The resources 119 can be received in response to user-input or action (e.g., purchasing input), or through automated programmatic action between the service 120 and the e-reading device 110 (e.g., automatic download of new issue of periodical based on user subscription data).

In one example, computing device 110 can execute the e-reading component 114 to enable e-reading activities. In one aspect, the e-reading component 114 can render paginated content from e-books (e.g., electronically formatted literary works). Many e-books, such as literary works which are primarily text-based (e.g., novels) can be paginated on-the-fly by the e-reading component 114, based on, for example, a display size of the device and/or font size settings of the user or device.

The browser 116 can browse web resources and render web content on the computing device 110. In an example of FIG. 1, the browser 116 can be conventional, capable of rendering text, images, and media. The browser plugin 118 refers to an application or programmatic component that executes with the browser 116. Accordingly, the browser plugin 118 executes not as a standalone application, but within the application framework of browser 116. In variations, the browser plugin 118 can be implemented as a standalone component, which interfaces or otherwise communicates with the browser to provide functionality such as described with various examples of plugin 118. Still further, in other variations, the browser 116 can include inherent functionality described with examples of the browser plugin 118, as described below. Thus, the browser plugin 118 provides one implementation for enhancing functionality of existing browsers to include capabilities such as described herein. In variations, the plugin 118 can be implemented as a standalone application or as an integrated feature or component of the browser 116.

In one embodiment, the browser plugin 118 can provide a link between the browser 116 and the network service 120. The link provided through the browser plugin 118 can be direct, meaning the browser 116 and/or plugin 118 can establish a communication session or channel with the network service 120. In variations, the link provided through the browser plugin 118 can be indirect. For example, the browser plugin 118 can link data obtained to the browser 116 to the e-reading component 114, which then communicates via the service interface 112 to the network service 120.

The browser plugin 118 can include functionality for enabling user selection of content items from the web resource. Depending on implementation, the selection of the content item can involve different format and type for source content. For example, the browser plugin 118 can enable content selection in the form of embedded content items provided on a portion of a web resource, such as encoded and provided within a hypertext markup language (HTML) formatted resource. Such embedded content can enable selection of discrete text and/or image items. As an addition or variation, the content selection can be for selection of non-discrete portions of rendered content. Examples of content types which have non-discrete portions include (e.g., JPEG (Joint Photographic Experts Group), GIF (Graphic Interchange Format), PNG (Portable Network Graphics, etc.)) or vectorized content (e.g., PDF (Portable Document Format)). Additionally, in some embodiments, execution of the plug-in can enable the user to select a rendered web page. For example, the user can make an icon selection that results in the text content and/or image content appearing on the web page to be scanned and analyzed as either text or image data.

The browser plugin 118 can trigger or otherwise invoke functionality and/or resources to perform content analysis on the selected portion of the web content. The content analysis can include (i) a text analysis process, to identify words that belong to a title of a work, (ii) an image recognition process, such as OCR (Optical Character Recognition), to detect alphanumeric characters depicted in image data, and/or (iii) a metadata analysis process, provided with the selected content item.

In one embodiment, the processes for content analysis are local to the computing device 110. The browser plugin 118 triggers the local processes to extract terms from the selected content which likely form at least a portion of a title referenced in the selected content.

In the variation, some or all of the processes for content analysis are remote to the computing device 110. The browser plugin 118 may detect selection of the portion of the web content, then invoke a call to a remote service in order to trigger one or more content analysis processes on the selected portion of the web content. The browser plugin 118 can implement programmatic processes to generate content data that is communicated to the remote service. In turn, the remote service can process the content data to determine terms that are likely part of the title that is referenced in the selected web content. Alternatively, the browser plugin 118 can signal information that locates and identifies the selected portion of the web content, enabling the remote service to directly retrieve the selected web content, implement the content analysis process(es), and return the terms that are likely part of the title referenced in the selected content. In some implementations, the content analysis processes of the remote service can be implemented as a feature of the network service 120.

According to an aspect, the browser 116 and plugin 118 operate to communicate a set of terms 129 that are likely part of a title of interest to the network service 120. The communication can be directed from the browser directly to the network service 120, or alternatively indirectly through the e-reading component 114 and/or service interface 112.

In an example of literary titles, the network service 120 receives a communication 117 from the computing device 110. The communication 117 can identify the account 125 associated with the computing device 110, as well as the title terms 129 of the title that is referenced in the selected web content.

In response to receiving the communication 117, the network service 120 can perform one or more operations to promote or advance a transaction for the selected title. In one implementation, device interface 128 identifies the account 125 of the computing device 110, and associates a corresponding e-book title 129 with an account item or function of account 125. In one embodiment, the corresponding e-book title 129, which is determined from the selected web content, is added to an acquisition queue 127 or wish-list of the account 125.

As an addition or variation, the e-book title 129 can be communicated to a transaction manager 150, which in turn implements a transaction operation to facilitate or complete a transaction for the particular e-book title 129. In one implementation, the transaction manager 150 automatically implements a transfer of the identified e-book title 129 to the account of the user. In transferring the title, the transaction manager 150 can automatically debit funds from the account of the user, or obtain other consideration from the user. In a variation, the transaction manager 150 uses the e-book title 129 to generate a transaction form or other interface for the e-book title. The transaction manager 150 can communicate a transaction interface 151 to the computing device 110. Once confirmation or approval input is received from the computing device, the transaction can be executed.

In variations, the transaction manager 150 determines transactional information for the corresponding e-book title 129 (e.g., price, reviews, similar titles or titles from same author). The transactional information 153 can be obtained from, for example, the content store 122 and then communicated to the user.

A communication 121 reflecting the result of the operations performed by the network service 120 can be returned to the user. In one implementation, the communication 121 can be in the form of a confirmation, including, for example, one or more of the following: (i) the e-book title 129 that was identified from the content selection initiated through the browser 116 and browser plugin 118; (ii) a communication indicating that the identified e-book title 129 has been added to the user's acquisition queue 127; (iii) transactional information 153 for the selected e-book, such as price for new or used versions of the e-book, reviews, or e-books by the same author, etc.; (iv) a prepared (or partially prepared) transactional interface 151 for completing a purchase order to acquire the e-book; (v) confirmation that the e-book was transferred to the user account, such as by way of a transaction; and/or (vi) a version of the e-book of the identified title, or portion thereof (e.g., free preview etc.).

The specific result that is performed can be based on default preferences of the network service 120, as well as on setting preferences of the user of the device 110. For example, some users may prefer to have e-book titles added to the wish list, while others wish to automate a transaction for purchase thereof.

According to some examples, the sequence of operations triggered by the browser plugin 118 when detecting the selected web content can be performed independently, and transparently to other application processes, including the continued use of the browser 116. In this way, the operations triggered by the browser plugin 118 can be implemented asynchronously relative to the continued use of the computing device 110.

### Hardware Description

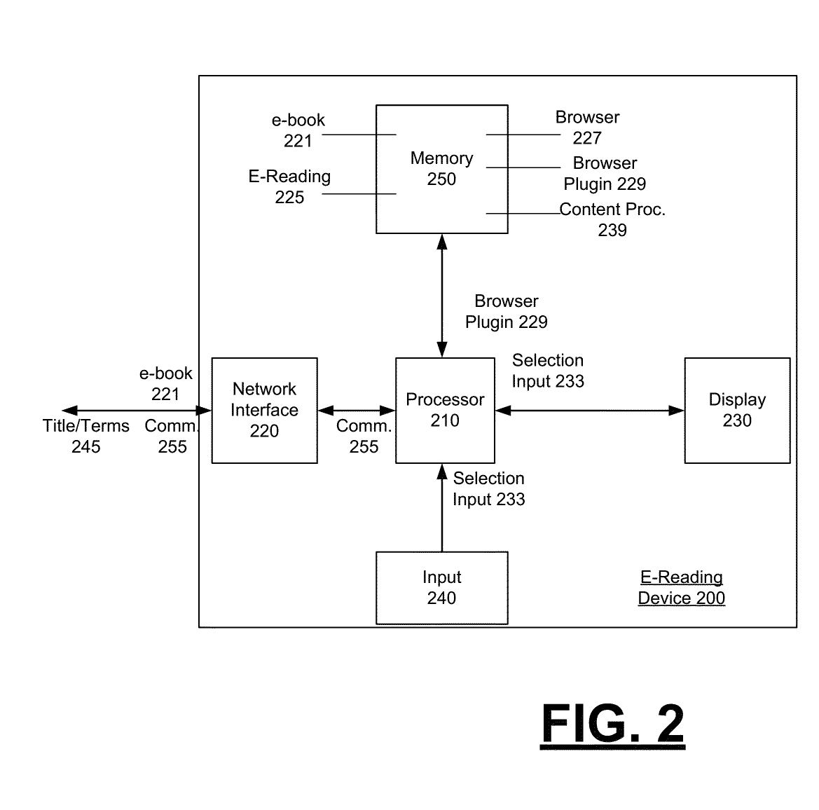

FIG. 2 illustrates an example of an e-reading device for use with one or more embodiments described herein. In an example of FIG. 2, an e-reading device 200 can correspond to, for example, a computing device such as shown by an example of FIG. 1.

With reference to FIG. 2, e-reading device 200 includes a processor 210, a network interface 220, a display 230, one or more input mechanisms 240, and a memory 250. The processor 210 can implement functionality using instructions stored in the memory 250. Additionally, in some implementations, the processor 210 utilizes the network interface 220 to communicate with the network service 120 (see FIG. 1). More specifically, the e-reading device 200 can access the network service 120 to receive various kinds of resources (e.g., digital content items such as e-books, configuration files, account information), as well as to provide information (e.g., user account information, service requests etc.). For example, e-reading device 200 can receive application resources, such as media files (e.g., e-books 221) that the user elects to purchase or otherwise download from the network service 120. The application resources that are downloaded onto the e-reading device 200 can be stored in the memory 250.

In some implementations, the display 230 can correspond to, for example, a liquid crystal display (LCD) or light emitting diode (LED) display that illuminates in order to provide content generated from processor 210. In some variations, the display 230 can correspond to an electronic paper type display, which mimics conventional paper in the manner in which they display content. Examples of such display technologies include electrophoretic displays, electrowetting displays, and electrofluidic displays.

In some implementations, the display 230 can be touch-sensitive. For example, the display 230 can be integrated with a sensor layer that is comprised of capacitive touch sensors which trigger with contact to human skin. Alternatively, the display 230 can include alternative sensor layers, such as resistive sensors which can detect applied pressure from, for example, a human finger or stylus.

The processor 210 can receive input from various sources, including from input mechanisms 240 (e.g., buttons or switches, microphone, keyboard), the display 230 (e.g., soft buttons or virtual keyboard) or other input mechanisms (accessory devices). In one implementation, the processor 210 can process multi-touch input detected by the sensor layer provided on the display 230.

In one aspect, memory 250 stores instructions 225 (“e-reading instructions 225”) for operating an e-reading application (e.g., see e-reader component 114 of FIG. 1). The memory 250 can also store instructions for implementing and browser (“browser instructions 227”) as well as instructions for a browser plugin (“browser plugin instructions 229”). In operation, the processor 210 can render portions of e-book 221 from memory, and display content from the selected e-book by executing e-reading instructions 225. Additionally, the e-reading component 114 executed through the e-reading instructions 225 is an example of a service application, capable of communicating with the network service 120 to receive resources such as e-books.

In one implementation, the processor 210 can execute the browser plugin instructions 229 with execution of the browser instructions 227. The processor 210 uses the browser plugin instructions 229 to detect the selection of web content by the user. The selection input 233 for selecting web content can be provided via the input mechanism 240, or through the display assembly 230 (e.g., through touch interface of a display screen provided with the display 230).

In some embodiments, the browser plugin instructions 229 invoke content analyses processes 239, which can also be stored locally with memory 250. The content analyses processes 239 identify terms (“title terms 245”) that are referenced or depicted in selected web content which are likely part of a title for a work (e.g., literary work). The identified title terms 245 can be communicated view the network interface 220 to the network service. As described with other examples, the e-reading device 200 can receive via the network interface 220 a service communication 255 pertaining to an identified title.

### E-Reading System

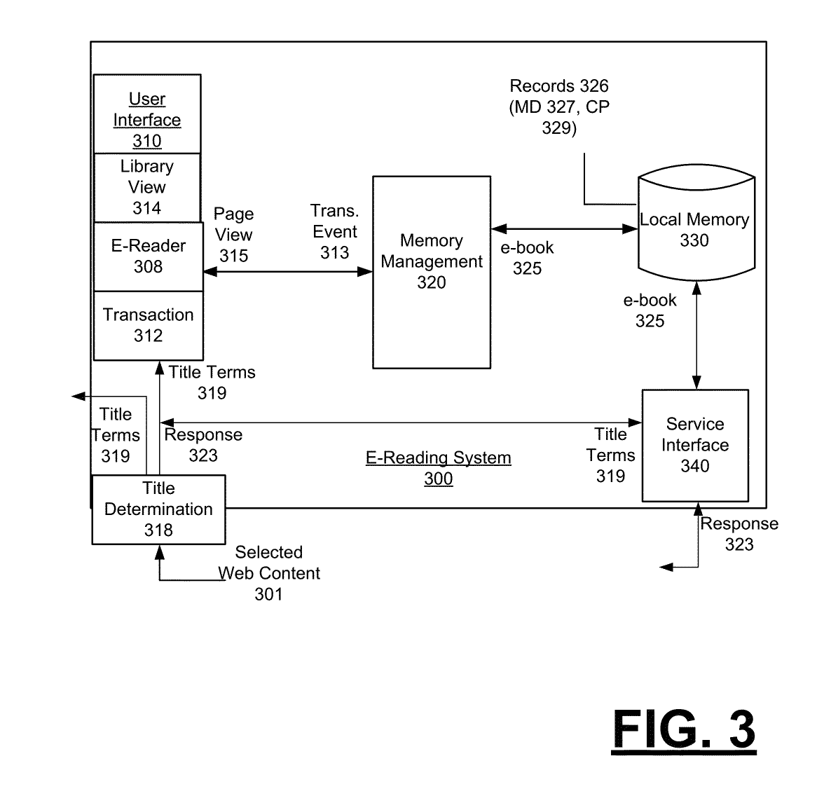

FIG. 3 illustrates an e-reading system which is implemented in connection with a title determination and acquisition process, according to one or more embodiments. In reference to FIG. 3, a system 300 implements programmatic components for communicating with one or more network services (such as network service 120, shown in FIG. 1), as well as for enabling functionality for viewing and accessing content items (e.g., e-books) utilized by an account associated with the e-reading device 110 (see FIG. 1). In some embodiments, the system 300 can be implemented as an application that runs on an e-reading device, such as shown with examples of FIG. 1 or FIG. 2. In variations, the system 300 can be implemented as part of the operating system for the e-reading device.

In an example of FIG. 3, some or all of the programmatic components shown with the computing system 300 can be provided in part as operating system-level components. Alternatively, the programmatic components shown with the computing system 300 can be provided as part of an application that runs on, for example, the computing device 110 (see FIG. 1). For example, the user can download an application onto the device that is operated as the computing device 110, in order to obtain functionality such as described with an example of FIG. 3, as well as to communicate with the network service 120. Alternatively, an application can be embedded or otherwise preinstalled with other programmatic elements for providing functionality such as described with system 300. Still further, in other implementations, the system 300 can be implemented by plural applications and application components executing on a computing device of a user.

In one embodiment, system 300 can be implemented using one or more service applications and a browser plugin or component. In such an embodiment, the network service 120 can provide some or all of the components for download and use with resources of the network service 120.

Still further, in some embodiments, system 300 includes a user interface 310, a memory management module 320, a local memory 330, and a service interface 340. Additionally, the system 300 includes a title determination sub-system 318 which identifies e-book titles of interest from user selected web content 301.

The service interface 340 includes application logic which enables the computing device 110 to use, for example, a wireless Internet connection, to connect to the network service 120 (see FIG. 1). In connecting with the service, the service interface 340 can transmit data that enables the network service 120 to identify the computing device 110 on which system 300 is implemented, so that the network service 120 can determine the account that is associated with the particular e-reading device. The service interface 340 can be used to retrieve or receive e-books 325 from the network service 120, which are then stored in the local memory 330. For example, in identifying the computing device 110 of system 300 to the network service 120, the network service may be able to procure payment information (e.g., stored credit card information) that can be used to charge the user's account when the user purchases a new e-book from the service. Each e-book can correspond to a literary work having a pagination format, such as provided by literary works (e.g., novels), as well as pagination provided by periodicals (e.g., magazines, comic books, journals, etc.). Many e-books may have chapter designations, as well as content that corresponds to graphics or images (e.g., such as in the case of magazines or comic books). Individual e-books 325 also include metadata 327, such as imagery provided as a cover for the e-book when the e-book is marketed (e.g. similar to the manner in which a conventional hardbound book would be marketed in a retail store). In one implementation, the network service 120 can retrieve or otherwise identify the imagery and other metadata 327 of individual e-books from publisher sources.

In identifying the e-reading device of system 300, the network service 120 can identify what e-books belong to the account associated with the particular device. The e-books that are transmitted to the e-reading device of system 300 can include, for example, those e-books that are purchased from the device, or those e-books that the user requested to download. In variations, e-books can be automatically downloaded to the device in response to occurrence of certain conditions. For example, the user can purchase an e-book on another device, and then subsequently connect to the network service 120 via the computing device 110 to automatically receive their previously purchased e-book. As another example, network service 120 can be configured to push e-books to the computing device 110 of system 300, based on, for example, user account settings, subscription plans and rules, and various other business logic considerations.

Additionally, the service interface 340 can include processes for automatically receiving updates from a network service 120. The update can include programmatic updates, including updates to software components on the computing device 110, as well as updates to lists, download of e-books that the user may have purchased on another device of the same account, recommendations from the network as to what a given user may want to purchase or view, and/or various other data that can be either generally provided to the user of the network service or specifically provided for to the particular account or user. According to some embodiments, the local memory 330 stores each e-book as a record 326 that includes metadata 327 and content 329 (e.g., page content).

The memory management module 320 can include a combination of memory resources, including cache resources that are coupled or integrated for use with the user interface 310 and/or e-reading component 308. The memory management module 320 can store portions of the content 329 for individual e-books for purpose of rendering e-books via the user interface 310. Additionally, the management module 320 can retrieve metadata 327 to render metadata content (e.g., representations of e-books or lists of e-books) with the user interface 310. By way of example, the memory management module 320 can include a cache resource (or combination of cache resources) that is utilized by the user-interface 310 to render e-book content in the format of a page, or combination of pages. The formatting of the portion of the e-book can be performed, for example, on-the-fly or in response to user input.

In an example of FIG. 3, the user interface 310 of e-book system 300 includes an e-reading component 308, a library view component 314, and a transaction component 316. The library view 314 can display objects and metadata that represent individual e-books and content items of the user library. In one implementation, the library view 314 can display metadata content based on the metadata portion 327 of individual e-books that are in the user library. The e-books that are in the user library can correspond to e-books stored with local memory 330, as well as archived e-books that are provided remotely (e.g., provided on network service 120).

More specifically, in some implementations, the memory management module 320 can be triggered into archiving e-books. In archiving an e-book, the content portion 329 of the e-book can be removed from the local memory 330, while the metadata portion 327 of the record 326 remains stored in the local memory 330. The trigger for archiving e-books can be based on the user input, or generated programmatically in response to events such as memory management processes (e.g., process to archive e-books that have been read; process to detect when free memory is below threshold, etc.). The library view component 314 can display the representation of the archived e-books using the metadata content 327.

The e-reading component 308 can generate page views 315 from portions of a given e-book 325. User input can specify page turns or transitions, shown as page events 313. In one implementation, the events 313 trigger the e-reading component 308 to retrieve additional portions of the e-book 325 from resources of the memory management 320 (e.g., cache) in order to render additional page views 315.

In one implementation, the transaction component 312 can correspond to an interface to an online store, such as provided with network service 120. The user can, for example, interact with the transaction component 312 in order to search for titles, view the user's acquisition queue 127, view and submit purchase orders, etc.

The title determination sub-system 318 can be implemented using one or more programmatic components that reside outside of system 300. In one embodiment, the title determination 318 includes a browser plugin and browser, with the plugin originating or being provided from the network service 120. The browser, on the other hand, can be generic or non-specific to the network service 120. The title determination 318 identifies selected web content that corresponds to a portion of a web resource rendered on the user device, and identifies title terms 319 from the analyzed content. In one implementation, the title determination 318 operates independently of other service applications or components, such as provided with the e-reading component 308 and/or transaction component 312. For example, the title determination 318 can communicate the set of title terms 319 to the network service directly, or through the service interface 340. In a variation, the title determination 318 can communicate the title terms 319 to the transaction component 312 for subsequent search and purchasing activity.

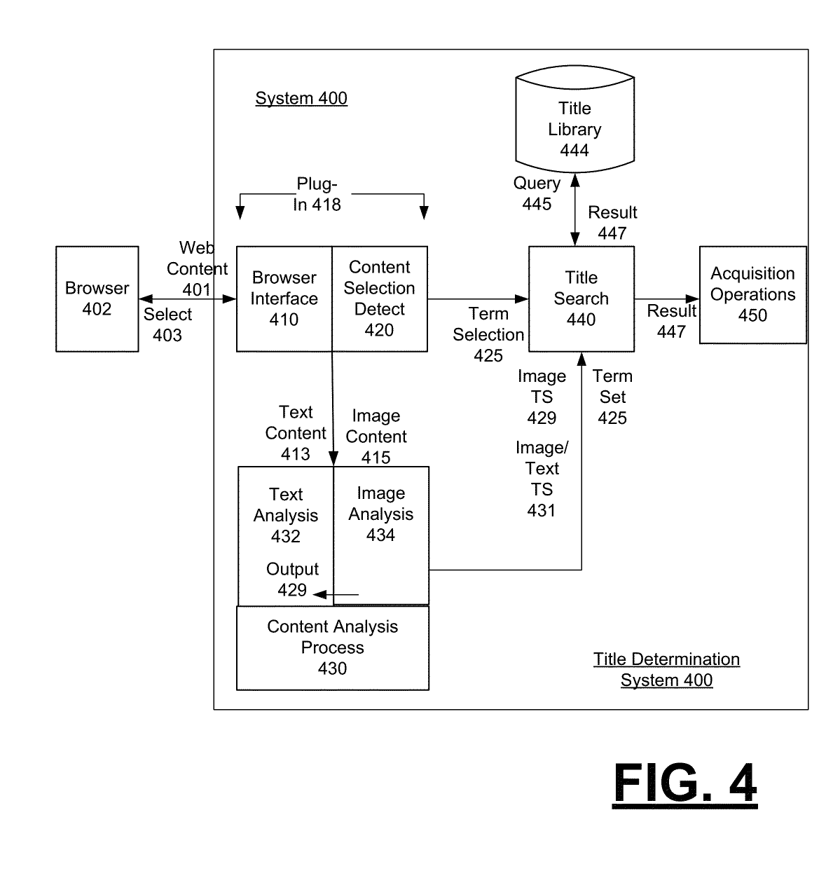

In an embodiment, the title determination 318 operates to initiate analysis of the web content selected by the user, in order to identify the set of title terms 319. An example of the title determination sub-system 318 is shown with FIG. 4.

In one implementation, the title terms 319 correspond to an exact title, and can be used on the e-reading device for a variety of operations. In an example of FIG. 1, the title terms 319 are communicated to the transaction component 312, which implements a search for the title on the network service 120. If the title is located, the user can be provided the option to purchase, preview, or add the title to an acquisition queue. Alternatively, if the title is located, the acquisition of the title can be performed automatically, or substantially automatically, such as in response to user input. Still further, if the title is located, another variation automatically adds the title to the acquisition queue 127 of the user account 125.

In variations, the title terms 319 are candidate components of a title. As candidates, the title terms 319 are used to perform a title search which results in identification of one or more matching titles. The title search can be performed on, for example, the network service 120, and the result of the title search can be returned to the title determination sub-system 318 and/or components of the service application.

Still further, the title determination 318 can communicate the title terms 319 to the network service to receive a transaction response 323. The transaction response 323 can include, for example, one or more of the following: (i) transactional information for a title identified by the title words 319; (ii) a confirmation that a title identified by the title words 319 was added to the user's acquisition queue 127; (iii) a completed or partially completed transaction form for the title identified by the title terms 129, which the user can confirm for submission; or (iv) a purchase order or receipt for a transaction in which the title identified by the terms was automatically purchased and assigned to the account of the user.

In variations, the response from the network service 120 can include a purchased or acquired e-book, delivered through the service interface 340. Still further, the service interface 340 can receive a record for the purchased e-book, which may include metadata 327, absent content portion 329 (pending user download). Still further, the network service 120 can respond with a preview version of the identified e-book title.

### Title Determination System

FIG. 4 illustrates a system for identifying a title of a work that is of interest to a user, using analysis of web content selected by the user. In reference to FIG. 4, a title determination system 400 can be implemented as a distributed system, utilizing (i) programmatic resources provided on a computing device of the user, (ii) a network service were content titles can be obtained, and (iii) optionally one or more remote services. In variations, a computing device of the user can implement the processes and functionality shown with system 400. By way of example, a computing device of system 400 can correspond to a computing device such as described with an example of FIG. 1, or an e-reading device such as described with an example of FIG. 2. Still further, a system 400 can be implemented in context of an e-reading system, such as described with an example of FIG. 3.

In an example of FIG. 4, system 400 includes a browser interface 410, a content selection and detection process 420, a content analysis component 430, a title search 440, and one or more acquisition processes 450. The browser interface 410 and content selection and detection process 420 can be implemented as or through a browser plugin 418. In variations, the browser interface 410 and content selection and detection process 420 can operate as an independent application or set of applications.

The content selection and detection 420 uses the browser interface 410 to (i) enable a user selection action 403 to be performed via the browser 402, and (ii) detect selection of a portion of web content 401 rendered through the browser 402. The selected portion of the web content can include (i) text data, and/or (ii) image data, such as provided by an embedded image, or a portion of a rasterized or vectorized content item. The browser plugin 418 can invoke one or more processes of content analysis 430 to extract identifiers for a likely title of interest that is referenced in the web content 401 of the user selection. The extracted identifiers can be in the form of text, and more specifically, terms that comprise some or all of the referenced title. In variations, the terms that comprise the title can correspond to key terms of the title, or a beginning portion of a title.

In some embodiments, each of the processes provided by content analysis 430 are available or are included with system 400. For example, the processes of content analysis 430 can be provided as application components that reside on the computing device 110. In more specific examples, the processes of content analysis 430 can be incorporated with a service application (e.g., e-reading component 114), or with resources provided from the network service 120 in connection with the computing device executing the service application. As another example, on or more of the processes of the content analysis 430 can be provided with the network service 120.

In variations, one or more of the processes of the content analysis component 430 can be provided with a remote service, such as through a third-party provider. In one implementation, the browser plugin 418 invokes a function call to the remote service, and further operates to either (depending on implementation preferences) (i) provide data to the remote service which corresponds to the selected web content 401, or (ii) identifies to the remote service where such content can be located. The remote service can implement the processes for extracting terms of the selected web content, and also for communicating the terms back to system 400 (e.g., to browser plugin 420).

In some embodiments, the browser plugin 418 provides for selection of text content 413. In a simple case, text content 413 can be assumed to correlate directly to terms in a title of an e-book. For example, the user can view an article that pertains to a work of fiction (e.g., “Wool” by Hugh Howey), highlight the specific term(s) of the title (e.g., “Wool”), and trigger follow-on processes, as described herein, once the term is selected. In such an implementation, the selected text content 413 can correlate directly to a term selection 425, which can be outputted for use by title search 440.

In variations, however, the user may select more than just the terms of a title, so that the text content 413 includes numerous more words than the actual title of the work being described in the web content 401. For example, the user may view an article about an author and see a title of the author's novel in the first paragraph. In such case, the selected text content 413 can be subjected to text analysis 432. The text analysis 432 can include rules and other logic for identifying terms that are likely part of a title. For example, text analysis 432 can use presence of capitalization to identify a title. For example, text analysis 432 can include rules that weight a string of capitalized words as likely being a title. Other forms of logic that can be used include proximity logic, to detect, for example, words (including capitalized words) appearing near designated marker words. Marker words can include terms that often proceed or follow titles. For literary works, marker words can include, for example, “novel” or “bestseller”. For movies, for example, marker words can include “blockbuster” or “Oscar”. These and other techniques can be used to extract terms that are likely part of a title from contextual words of the selected text content 413.

According to some embodiments, the browser plugin 418 can also enable selection of image content 415 from the rendered web content 401. The content analysis processes 430 can include image analysis 434, which can perform, for example, OCR on the image content 415. In the simple case, the image content 415 can detect metadata content associated with the title, such as a book cover image. In such cases, application of image analysis 434 yields image analysis term set 429, corresponding to a few select words, each of which are pertinent to a search for the title. Accordingly, in some examples, the term set 429 of image analysis 434 can yield terms that comprise the title, as well as other relevant terms for identifying the title, such as a name of an author of the title.

In many cases, the term set 429 of the image analysis 434 can yield more than a few terms. In such cases, the term set 429 of the image analysis 434 can be subject to text analysis 432. For example, the content selection 415 may be in the form of image data, corresponding to the user identifying a section of a rasterized or vectorized content. In such formats, it may be difficult for the user to highlight specific terms, rather the user highlights a larger portion of text content. The image analysis term set 429 can be subjected to text analysis 432 to yield image/text term set 431.

The title searching component 440 receives a term set as input from performance of text analysis 432 and/or image analysis 434. The title searching 440 can have access to a library of titles 444. Search logic can be provided with the title searching component 440, in order for the title searching component 440 to generate a title query 445. The title query 445 can include some or all of the terms of a given title. The result of the quarry 445 can yield a title of a work. In some variations, multiple titles can be returned if there is uncertainty to the exact title, based on mismatch of individual words or some words being missing. The result 447 can be communicated to an acquisition process 450, which implements one or more operations to initiate or otherwise advance a transaction for an electronic version of the title.

In some embodiments, the title search 440 and acquisition process 450 are implemented on a network service 120. For example, with reference to FIG. 1, the computing device 110 can implement or otherwise trigger processes to determine a likely term set for a title. The computing device 110 can communicate the likely term set to the network service 120, which in turn determines the title and performs one or more of the acquisition processes.

The acquisition operations 450 can include operations performed by network service 120, computing device 110, or by the combination of the network service and computing device 110. In one implementation, the acquisition operation 450 determines information, such as transaction information, for the identified title. A communication can be provided to the computing device 110 which provides, for example, the publisher's metadata content for the title (e.g., jacket cover art), a transaction price for acquiring the title, as well as other information such as the name of the author, reviews for the title, and similar titles of interest.

In another variation, the acquisition operations 450 can include performance of one or more operations to associate an identified title of interest with an acquisition queue 127 (see FIG. 1) of a user account. In one implementation, an acquisition operation 450 can assign a title provided with result 447 to the acquisition queue 127 of the user.

Still further, the acquisition operations 450 can be implemented by the transaction manager 150 (see FIG. 1) to associate the title identified by the result 447 with the user account 125. Thus, for example, when the user selects the web content, the follow on steps that are performed result in the title being acquired by the user. The transaction manager 150 can, for example, debit the user account.

In a variation, the transaction manager 150 implements the acquisition operations 450 by completing a transaction form or interface for implementing the transaction. For example, a purchase order can be prepared that identifies the title and the transaction amount, and identifies the payment information, pending confirmation or approval input from the user. Thus, rather than automatically implement the purchase, a variation provides that a transaction form is provided to the user to enable the purchase to be complete with selection input from the user.

In some variations, the title search 440 is implemented on the computing device 110. For example, the title search 440 can be implemented by the e-reading component 114, which prepares and communicates the query 445 to a network service where the library 444 is provided. Additionally, some embodiments provide for implementing operations of acquisition process 450 on the computing device. For example, in one variation, when the title is determined from result 447, a transaction component can execute on the computing device 110 to initiate or complete a transaction form for purchasing the identified title.

### Methodology

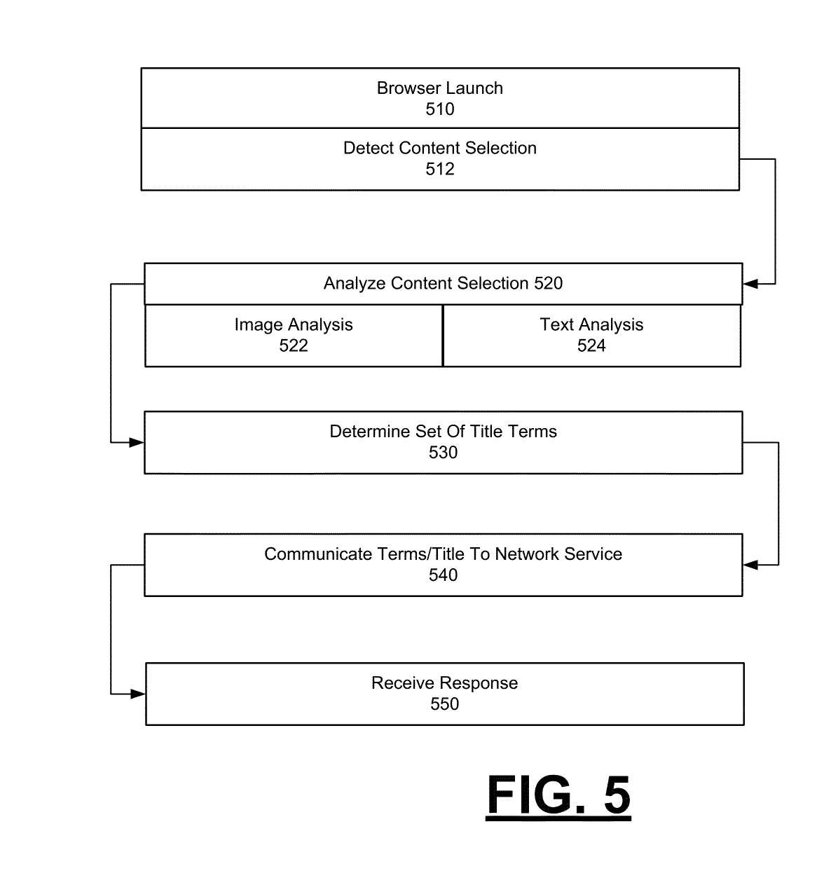

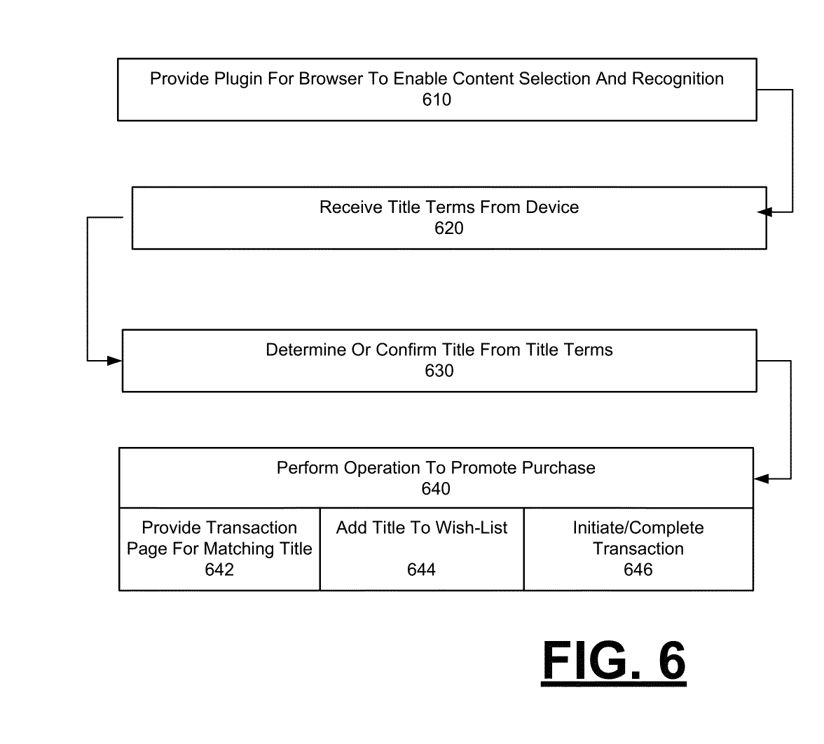

FIG. 5 illustrates an example method for analyzing user selected web content to identify a title of a work that is referenced by the web content, according to an embodiment. FIG. 6 illustrates an example method for implementing one or more acquisition operations in response to identifying a referenced title in user selected web content, according to an embodiment. Examples such as described by FIG. 5 and FIG. 6 can be implemented using components such as described with other embodiments described herein. Accordingly, reference may be made to elements of other figures for purpose of illustrating suitable elements or components for performing a step or sub-step being described.

With reference to FIG. 5, a browser on the computing device 110 of the user is launched and operated to access web pages of the user's choosing (510). For example, the user can navigate to various news articles and websites of interest, such as those relating to books, movies or television programs of interest to the user. When the user sees a reference to a title (e.g., novel) of interest, the user can select the term or portion of the web content on which the reference to the title is made. In one implementation, if the reference is in the form of text, the user can select a combination of terms that form the title. In some variations, the user can grab terms in addition to those that reference the title. For example the user can grab a sentence or paragraph that references the title of interest. Still further, in variations, the content selection can correspond to an image (e.g., person holding a book of interest). The content itself can also be text-based, but an image format (e.g., PDF document).

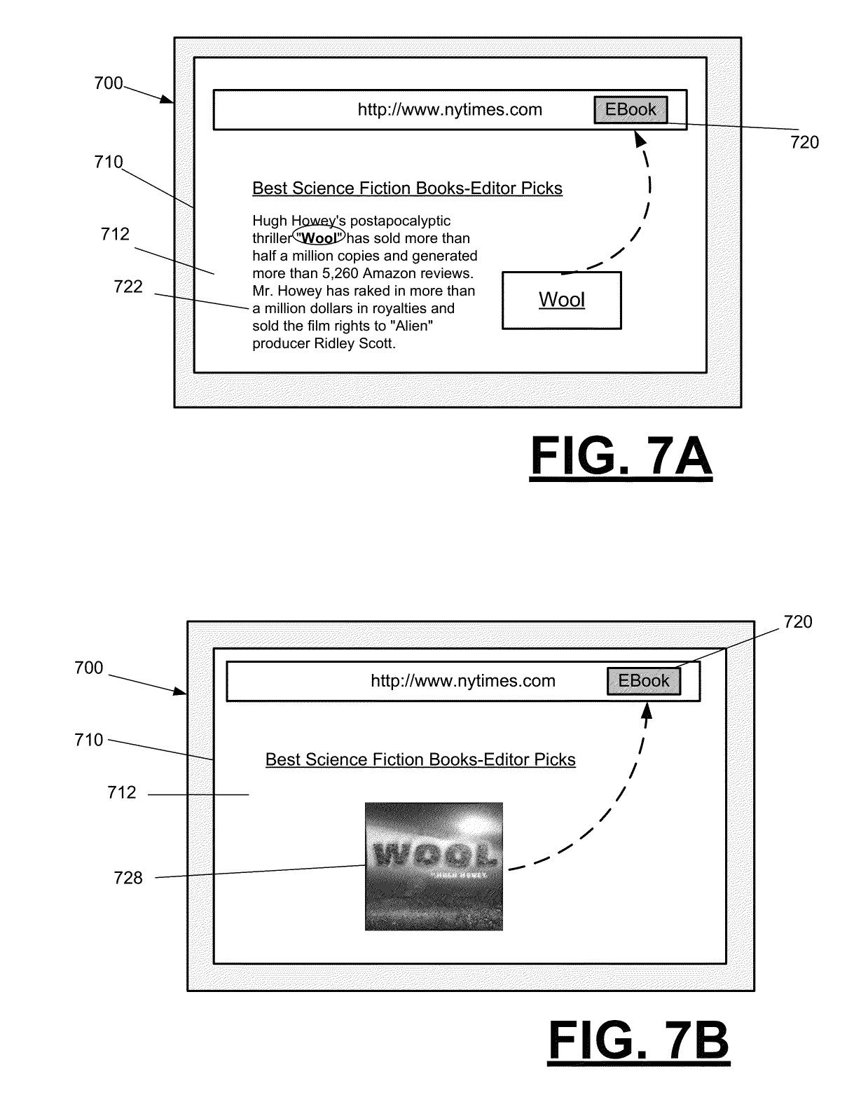

The selection of the content by the user can be detected by a browser component, such as browser plugin 118 (512). In one embodiment, the browser plug-in triggers a process to scan the web page for content, including text or image content. In such an embodiment, an icon other user interface feature can be provided to initiate a scan of the web rendered by the browser. In a variation, a user can operate the computing device 110 to identify a segment of web content that includes a reference to a title of interest. In one implementation, the browser plugin 118 can provide a “clipping” feature that enables the user to delineate a section of interest from a remainder of the web content. As shown with an example of FIG. 7A or FIG. 7B, the user can clip the section of the web content, and drag the section to an icon or other visual indicator to designated input action for content selection. Once the action is complete, the browser plugin 118 detects the content selection, and initiates subsequent processes for making the title determination and/or performing operations to promote or advance acquisition of a title referenced in the content selection.

The selected content can be analyzed to identify at least some of the terms that comprise the title (520). In one embodiment, the content analysis is performed using processes that are local to the computing device 110. For example, the computing device 110 can include one or more applications which perform analysis such as described below. In the variation, the computing device 110 can invoke remote processes, hosted on network sites, in order to perform content and/or text analysis. For example, the browser plugin 118 can invoke processes performed at remote sites by third parties in order to perform text and/or image analysis, as described below.

Further as described with other examples, the analysis can include image analysis (e.g., OCR) to detect a set of terms depicted in an image (522). As an addition are alternative, the content analysis can include text-based analysis (524). Text-based analysis can be relevant when image analysis is performed, in that the text recognized from the image analysis can include more than just terms of a title. Likewise, text-based analysis can be needed when the user performs content selection by grabbing more content than just the terms of the title. As described with other examples, the text-based analysis can be rule-based, to identify, for example, terms or a series of terms that are capitalized or specially formatted. Other rules and logic can also be used to perform the text-based analysis and determine terms that are likely part of a title.

From the analysis, a set of terms are identified which are likely components of a title of interest (530). In some embodiments, the identification of the set of terms can be done on the computing device, which either implements the processes, or collects results from processes that are performed remote to the computing device.

As described with some examples, the set of identified terms can be imperfect in correlation to the actual title referenced in the selected content. For example, the set of identified terms can include more or fewer terms than exist in the actual title, or include one or more terms that are incorrect or misspelled. This set of terms can be communicated to a component that is able to perform a title search. In one implementation, the computing device 110 communicates the set of terms to the network service 120, which includes a library of titles for performing search based on criteria identified by the set of terms (540). Search logic can be used to correct for omissions, additions and erroneous terms in the set of terms, thereby identifying a title, or set of candidate titles that correspond to a reference title in the user selected content.

In one embodiment, computing device 110 receives a response from the network service 120 (550). The response can vary, depending on the implementation or mode of operation deployed. Examples of responses that can be provided from network service 120 are illustrated with FIG. 6.

With reference to FIG. 6, a network service 120 can operate to provide a plugin for browser of a computing device (610). The browser plugin can be pre-associated with an account maintained at the service 120. When the browser plugins operated, the network service 120 can receive a set of title terms from the computing device 110 (620). The network service 120 can either confirm the title, or determine the title from the title terms (630).

Once the title is identified or confirmed, the network service 120 can initiate or otherwise perform an operation or set of operations to advance a purchase for the title (640). In one implementation, the title identified from the selected web content is displayed to the user. In the variation, a set of options are displayed to the user alongside identify title. The options can include prompts for the user to perform additional input actions (e.g., provided through icons), such as to trigger performance of operations described with (642)-(646).

In one implementation, a transaction page for purchasing or otherwise acquiring a right of possession to the identified title is provided (642). The transaction page can identify the title, display the transaction price, and provide other information about the title (e.g., author, reviews, etc.). The transaction page can also pre-populate or otherwise be associated with account information so that the user can trigger purchase of the content item with a simple input (e.g., icon selection).

As an alternative or addition, the network service 120 can provide the user with a prompt or confirmation that the identified title was added to the user's acquisition queue 127 (644). As still another variation, a transaction for the identified title can be initiated or completed (646). For example, the transaction page can receive user input confirming authorization to withdraw funds for the identified title. Alternatively, the user can be displayed a receipt that shows purchase of the identified title.

### Examples

FIG. 7A and FIG. 7B illustrate examples for implementing title determination using a browser plugin for detecting in processing user-selected web content, according to one or more embodiments. In an example of FIG. 7A and FIG. 7B, an e-reading device 700 includes a display screen 710, on which a web page 712 is rendered by a browser operating on the computing device. A browser plugin (e.g., see browser plugin 118) executes with the browser and, its trigger is displayed to the user by the way of icon 720. In one embodiment, the icon 720 can be a triggerable feature, and its selection can initiate a process in which the plug-in scans the web page rendered through the browser for text content, image content or both. If text content is identified, text analysis can be performed to determine terms that are likely to reference a title. If image content is identified, image analysis can be performed to determine text terms, which can then be further analyzed for titles.

In a variation, text content 722 references an e-book title “Wool”, and the user highlights the term(s) of the title (“Wool”) and performs an action such as dragging the term to the icon 720 of the plugin. In another implementation, the user can drag a paragraph of text content 722 to the icon 720. The identified title term(s) can then be used to perform acquisition operations, such as described with other embodiments described herein. In another variation, a user can perform an alternative selection action, such as “right-clicking” terms or even an image appearing on the web page. The selection action results in identification of selected terms from which the title can be determined. Such a variation can also be implemented as an alternative in instances when content items from a web page cannot be “dragged”.

With reference to FIG. 7B, the user can select an image content 728 from the web page 710. The image selection can be implemented as a functional web clipper. In the example provided, the image content 728 corresponds to metadata content provided by the publisher for the identified title. The image can be dragged to the icon 720 to signify the input action for initiating image analysis on the image content 728. As a result of the image analysis, the title term(s) can be identified and subsequently used to perform acquisition operations, such as described with other embodiments described herein. As described with other examples, a variation provides for the user to be able to execute the plug-in to “right click” or select the image on the web page. Such a variation can also be implemented as an alternative in instances when content items from a web page cannot be “dragged”.

In one implementation, the image analysis performed on the image content 728 can be OCR, to detect alphanumeric characters appearing in the content. In variations, the image content 728 can be subjected to image recognition, rather than OCR. For example, a recognition signature can be obtained for metadata content (e.g., jacket art) and then compared to a library of signatures for jacket art of other titles in order to determine the title term(s) depicted in the image content. Thus, for example, the content analysis process 430 (see FIG. 4) can employ image recognition in the form of image signature comparison and similarity determination, for certain kinds of images (e.g., metadata content) which themselves are identifiers for a corresponding title.

While some examples described herein utilize title terms for purpose of identified e-book titles, in the context of e-books, other terms of identification for literary works can also be used. In particular, author names can be used to generate a set of one or more titles that were authored by the given individual. The titles identified from the author name can then be subjected to acquisition operations in activity, as described with numerous examples provided herein.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computing device comprising:
a memory resource to store application data for a plurality of applications, the plurality of applications including a service application that communicates with a network service, a browser application, and a browser plugin for the browser application;
one or more processors that access the memory resource to:
operate the browser plugin to detect when a user selects a portion of web content rendered by the browser application;
identify a title of a work from the web content;
associate the title with an account maintained at the network service from which a digital form of the work can be obtained, the account being linked to the computing device.

2. The computing device of claim 1, wherein the one or more processors identify the title by extracting a set of terms from the web content, and then identifying the title using the set of terms.

3. The computing device of claim 2, wherein the one or more processors identify the title by communicate the set of terms to a remote service to identify the title of the work.

4. The computing device of claim 2, wherein the one or more processors identify the title by (i) executing the plugin to communicate data based on the web content to the service application, and (ii) executing the service application to determine the title from a remote service.

5. The computing device of claim 1, wherein the one or more processors execute the plugin to communicate directly with the network service, the plugin communicating data based on the selected web content.

6. The computing device of claim 1, wherein the one or more processors identify the title by communicating data corresponding to the selected web content to a second network service that implements content analysis in order to determine at least a portion of the title.

7. The computing device of claim 1, wherein the one or more processors implement a text analysis process to determine the title from the selected web content.

8. The computing device of claim 1, wherein the one or more processors implement an image analysis process to determine the title from image data included with the selected web content.

9. A method for operating a computing device, the method being implemented by one or more processors and comprising:
identifying a user selecting a section of a web resource that is accessed through a browser operating on a computing device operated by the user, the section of the web resource displaying content that depicts or references a title of a work without use of an e-commerce link for the work;
implementing analysis of the section of the web resource to determine at least some of the terms for the title; and
communicating at least some of the terms for the title to a network service to determine information for, or initiate, acquisition of an electronic version of the title.

10. The method of claim 9, wherein identifying the user selecting the section of the web resource includes executing a plugin for the browser.

11. The method of claim 9, wherein implementing analysis of the section of the web resource includes performing at least one of a text or image analysis to determine the title of the work.

12. The method of claim 9, wherein implementing analysis of the section of the web resource includes communicating data based on the section of the web resource to a remote service for performance of text or image analysis.

13. The method of claim 9, wherein communicating at least some of the terms for the title includes associating the title with an account maintained with the network service, wherein the account is linked to the computing device.

14. The method of claim 9, further comprising receiving a communication from the network service that specifies the title, and providing, from the computing device, a response for performing an action of acquiring or accessing the title.

15. The method of claim 9, further comprising updating, on the computing device, a wish list for acquiring works to include the determined title of the work.

16. The method of claim 9, further comprising receiving, on the computing device, a purchase order for acquiring the title of the work.

17. The method of claim 9, further comprising receiving, on the computing device, an electronic copy of the work.

18. A computer system comprising:
one or more servers to provide a network service;
a service application;
a browser plugin;
wherein the service application and the browser plugin operate on a computing device that is in communication with the network service;
wherein the plugin operates to:
identify a user selecting a section of a web resource that is accessed through a browser operating on a computing device operated by the user, the section of the web resource displaying content that depicts or references a title of a work without use of an e-commerce link for the work;
initiate or perform a content analysis process to identify at least a set of terms for title of the work;
wherein at least one of the service application or plugin operate to identify at least the set of terms of the title to the network service;
wherein the one or more servers of the network service operate to perform one or operations for promoting or completing a transaction to transfer a copy of the title to an account associated with the computing device.

19. The computer system of claim 18, wherein the one or more servers perform the one or more operations that include one or more of (i) identifying and displaying a transaction page for purchasing the title of the work; (ii) adding the title of the work to a wish-list associated with the computing device; or (iii) automatically completing a transaction to transfer an electronic copy of the title to an account of the user.

20. The computer system of claim 19, wherein the content analysis process is performed on the computing device.
